(19) United States
(12) Patent Application Publication
(10) Pub. No.: US 2010/0169165 A1
(43) Pub. Date: Jul. 1, 2010

(54) METHOD FOR UPDATING REGRESSION COEFFICIENTS IN A CAUSAL PRODUCT DEMAND FORECASTING SYSTEM

(76) Inventors: Arash Bateni, Toronto (CA); Edward Kim, Toronto (CA); Philippe Dupuis Hamel, Lavel (CA); Stephen Szu Chang, Waterloo (CA)

Correspondence Address: JAMES M. STOVER;TERADATA CORPORATION, 2835 MIAMI VILLAGE DRIVE, MIAMISBURG, OH, 45342, US

(21) Appl. No.: 12/648,980

(22) Filed: Dec. 29, 2009

Related U.S. Application Data
(60) Provisional application No. 61/142,025, filed on Dec. 31, 2008.

(51) Int. Cl. G06Q 10/00; G06F 17/30

(52) U.S. Cl. 705/10; 707/802; 707/E17.044

(57) ABSTRACT

An improved method for forecasting and modeling product demand for a product. The forecasting methodology employs a causal methodology, based on multiple regression techniques, to model the effects of various factors on product demand, and hence better forecast future patterns and trends, improving the efficiency and reliability of the inventory management systems. A product demand forecast is generated by blending forecast or expected values of the non-redundant causal factors together with corresponding regression coefficients determined through the analysis of historical product demand and factor information. The improved method provides for the saving and updating of previously calculated intermediate regression analysis results and regression coefficients, significantly reducing data transfer time and computational efforts required for additional regression analysis and coefficient determination.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/142,025, entitled “METHOD FOR UPDATING REGRESSION COEFFICIENTS IN A CAUSAL PRODUCT DEMAND FORECASTING SYSTEM” by Arash Bateni, Edward Kim, Philippe Dupuis Hamel, and Stephen Szu Chang; filed on Dec. 31, 2008.

This application is related to the following co-pending and commonly-assigned patent applications, which are incorporated by reference herein:

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

Application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar Atwal, and J. P. Vorsanger; and

Application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong.

### FIELD OF THE INVENTION

The present invention relates to methods and systems for forecasting product demand using a causal methodology, based on multiple regression techniques which models the effects of various factors on product demand to forecast future product demand patterns and trends, and in particular to a method for reducing regression calculation runtime and labor.

### BACKGROUND OF THE INVENTION

Accurate demand forecasts are crucial to a retailer's business activities, particularly inventory control and replenishment, and hence significantly contribute to the productivity and profit of retail organizations.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

In application Ser. Nos. 11/613,404; 11/938,812; and 11/967,645, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, seasonality of demand, product price changes, promotional activities, weather forecasts, competitive information, and other factors. A product demand forecast is generated by blending the various influencing causal factors in accordance with corresponding regression coefficients determined through the analysis of historical product demand and factor information. Up to four years of historical data, i.e., the history of product demand and causal variables, is used to create regression models. These models are normally created at the store-SKU (stock keeping unit) level and describe the relation of demand with each of the influencing causal variables.

Considering the large number of store-SKU's that may be maintained within a retailer's inventory, the scalability of the regression algorithms and products are very important. Performing the regression analysis on a weekly basis at the store-SKU level is computationally expensive, and may not satisfy scalability requirements. Normally, as new data becomes available, regression models are rebuilt using an Initial Program Load (IPL) approach, wherein previously calculated regression coefficients are discarded and new regression models generated using all of the available data. New techniques that can reduce computational efforts, without compromising the accuracy of the regression models, are desired.

A novel methodology that can significantly reduce regression calculation runtimes, without loss of accuracy, is presented below. The new method attempts to update previously calculated regression coefficients, rather than recalculate regression models, as new data becomes available. This can be done by storing temporary matrices used in regression analysis and updating them with the new data.

### BRIEF DESCRIPTION OF THE DRAWINGS

FIG. 1 is a flow diagram illustrating a method for determining product demand forecasts utilizing a causal methodology.

FIG. 2 is a diagram illustrating the step of saving regression matrices during the calculation of regression coefficients.

FIG. 3 is a diagram illustrating a method for updating previously stored regression matrices in accordance with the preset invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

y=b₀+b₁x₁+b₂x₂+ . . . +bₖxₖ (EQN 1);

where y represents demand; x₁ through xₖ represent causal variables, such as current product sales rate, seasonality of demand, product price, promotional activities, and other factors; and b₀ through bₖ represent regression coefficients determined through regression analysis using historical sales, price, promotion, and other causal data.

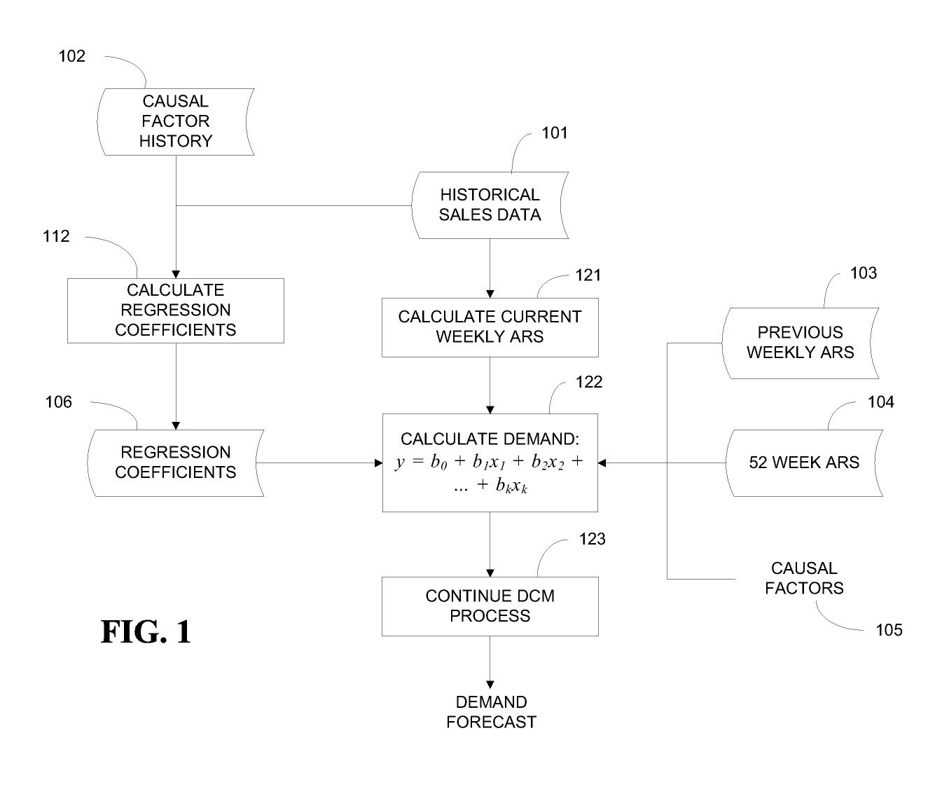

FIG. 1 is a flow chart illustrating a casual method for estimating product demand at weekly intervals. As part of the DCM demand forecasting process, historical demand data 101 is saved for each product or service offered by a retailer. The DCM system also determines and saves previous weekly Average Rate of Sale (ARS) and 52-week ARS data, 103 and 104, respectively; and price, promotional and other causal factor history 102.

In step 112, regression coefficients (b₀ through bₖ) are calculated using historical sales data 101 and causal factor historical information 102. Results are saved as data 106. This calculation may be run weekly to update the coefficients as new sales data becomes available.

In step 121 of FIG. 1, the current weekly ARS for a product is calculated from historical demand data 101. In step 122, the product demand forecast is determined by blending the Average Rate of Sale (ARS) from step 121 with the previous and 52^{nd} lags of the weekly demand from data stores 103 and 104, respectively, and other causal factor data 105. The current ARS (x₁), previous weekly ARS (x₂), 52-week ARS (x₃), and other causal factors (x₄ through xₖ) are blended in accordance with EQN1, with the regression coefficients (b₀ through bₖ) calculated in step 112. Although separate data stores are indicated by reference numerals 101 through 106, the stored data may be saved in a single storage device or database.

At step 123, the DCM forecasting process continues to generate and provide demand forecasts, product order suggestions, and other information of interest to a retailer.

The regression analysis performed in step 112 consists of calculating the regression coefficients that best fit equation EQN 1 to the available historical demand and causal data. The deviation of the regression equation from the actual data can be expressed as:

$$SSE = {\sum }_{i = 1}^{n} {e}_{i}^{2} = {\sum }_{i = 1}^{n} {( {y}_{i} - {b}_{0} - {b}_{1} {x}_{1 i} - {b}_{2} {x}_{2 i} - … - {b}_{k} {x}_{ki} )}^{2} \qquad ( EQN 2 )$$

where n is the number of observations, i.e., weeks of history. It can be shown that the minimization of Equation EQN 2 leads to the following system of linear equations: Ab=g (EQN 3), where b is the matrix of regression coefficients to be calculated. Matrices A, b, and g are shown below:

$$b = [ \begin{matrix}{b}_{0} \\ {b}_{1} \\ {b}_{2} \\ ⋮ \\ {b}_{k}\end{matrix} ] ; \\ A = [ \begin{matrix}n & {\sum }_{i = 1}^{n} {x}_{1 i} & {\sum }_{i = 1}^{n} {x}_{2 i} & … & {\sum }_{i = 1}^{n} {x}_{ki} \\ {\sum }_{i = 1}^{n} {x}_{1 i} & {\sum }_{i = 1}^{n} {x}_{1 i}^{2} & {\sum }_{i = 1}^{n} {x}_{1 i} {x}_{2 i} & … & {\sum }_{i = 1}^{n} {x}_{1 i} {x}_{ki} \\ ⋮ & ⋮ & ⋮ & & ⋮ \\ {\sum }_{i = 1}^{n} {x}_{ki} & {\sum }_{i = 1}^{n} {x}_{ki} {x}_{1 i} & {\sum }_{i = 1}^{n} {x}_{1 i} {x}_{2 i} & … & {\sum }_{i = 1}^{n} {x}_{ki}^{2}\end{matrix} ] ; \\ and \\ g = [ \begin{matrix}{g}_{0} = {\sum }_{i = 1}^{n} {y}_{i} \\ {g}_{1} = {\sum }_{i = 1}^{n} {x}_{1 i} {y}_{i} \\ ⋮ \\ {g}_{k} = {\sum }_{i = 1}^{n} {x}_{ki} {y}_{i}\end{matrix} ] . \qquad ( EQN 4 )$$

Normally, when new data points become available, the regression coefficients are recalculated. This process consists of retrieving all of the available data, recalculating matrices A and g, and solving the system of equations for b.

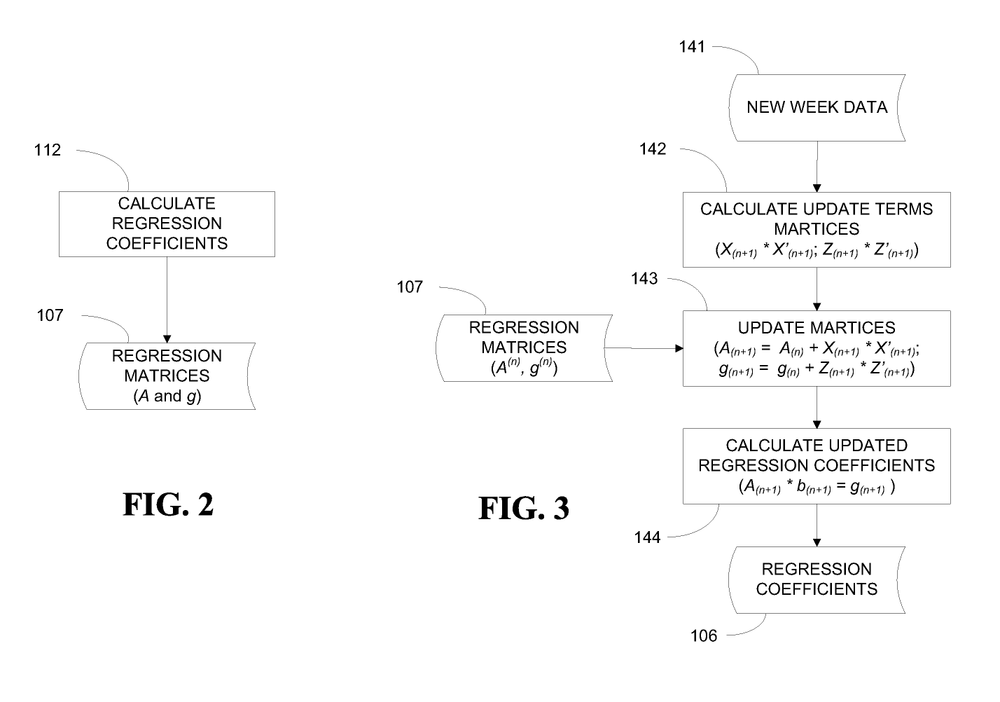

In the update method presented herein, the matrices A and g are stored after calculation, as shown in FIG. 2, and are simply updated whenever new data is provided. This approach significantly reduces the data transfer time and computational effort required for matrix calculation. The process for updating matrices A and g is illustrated in FIG. 3. The discussion which follows describes the updating of matrix A. This same process is used to update matrix g.

Let A⁽ⁿ⁾ be the matrix A calculated for n weeks of data using Equation EQN 4. When one additional week of data 141 becomes available, the new matrix A⁽ⁿ⁺¹⁾ can be calculated as follows:

$${A}^{( n + 1 )} = {A}^{( n )} + [ \begin{matrix}1 & {x}_{1 , n + 1} & {x}_{2 , n + 1} & … & {x}_{k , n + 1} \\ {x}_{1 , n + 1} & {x}_{1 , n + 1}^{2} & {x}_{2 , n + 1} \cdot {x}_{1 , n + 1} & … & {x}_{k , n + 1} \cdot {x}_{1 , n + 1} \\ ⋮ & ⋮ & ⋮ & & ⋮ \\ {x}_{k , n + 1} & {x}_{1 , n + 1} \cdot {x}_{k , n + 1} & {x}_{2 , n + 1} \cdot {x}_{k , n + 1} & … & {x}_{k , n + 1}^{2}\end{matrix} ] . \qquad ( EQN 5 )$$

Therefore, in the update approach, only the second term on the right hand side of equation EQN 5 needs to be calculated. This is possible since the new term is independent from the data of the previous weeks, i.e., only the recently provided data is needed to calculate the update term.

Assuming that X is the recently provided week of data, X₍ₙ₊₁₎=└1 x_{1,n+1} x_{2,n+1} . . . x_{k,n+1}┘ (EQN 6), the update term can be simply calculated as:

$${X}_{( n + 1 )} \cdot {X}_{( n + 1 )}^{′} = [ \begin{matrix}1 & {x}_{1 , n + 1} & {x}_{2 , n + 1} & … & {x}_{k , n + 1} \\ {x}_{1 , n + 1} & {x}_{1 , n + 1}^{2} & {x}_{2 , n + 1} \cdot {x}_{1 , n + 1} & … & {x}_{k , n + 1} \cdot {x}_{1 , n + 1} \\ ⋮ & ⋮ & ⋮ & & ⋮ \\ {x}_{k , n + 1} & {x}_{1 , n + 1} \cdot {x}_{k , n + 1} & {x}_{2 , n + 1} \cdot {x}_{k , n + 1} & … & {x}_{k , n + 1}^{2}\end{matrix} ] . \qquad ( EQN 7 )$$

Similarly, the regression matrices can be updated using several, e.g., m, weeks of new data:

$${A}^{( n + m )} = {A}^{( n )} + {\sum }_{j = n + 1}^{n + m} {X}_{( n + j )} \cdot {X}_{( n + j )}^{′} . \qquad ( EQN 8 )$$

This process is shown in FIGS. 2 and 3. Regression matrices A and g are saved during regression coefficient calculation (step 112) as shown in FIG. 2. Referring to FIG. 3, when new data 141 becomes available, update terms matrices X_{(n|j)}*X′_{(n|j}) and Z_{(n|j)}*Z′_{(n|j)} are calculated for matrices A and g, respectively, as shown in step 142.

The previously stored regression matrices 107 are updated using the update terms matrices from step 142 and equation EQN 8 as shown in step 143. Updated regression coefficients are calculated in step 144. The updated regression matrices can be stored over the previous regression matrices A and g for use in future updates.

### Conclusion

The Figures and description of the invention provided above reveal a novel method for updating previously calculated regression coefficients utilized in a causal demand forecasting system, significantly reducing data transfer time and computational efforts required for regression analysis. Although the invention as described above is utilized within a demand forecasting system, other data analysis applications may benefit from inclusion or use of the methodology described herein.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching

What is claimed is:

1. A computer-implemented method for forecasting product demand for a product, the method comprising the steps of:
maintaining, on a computer, an electronic database of historical product demand information and historical causal factor information for a plurality of factors influencing demand for said product;
analyzing, by said computer, said historical product demand information and said historical causal factor information for said product to determine a plurality of regression coefficients corresponding to said plurality of factors;
storing, on said computer, intermediate regression analysis results generated during said determination of said regression coefficients;
blending, by said computer, said plurality of regression coefficients and corresponding plurality of factors for said product to determine a product demand forecast for said product;.
receiving, by said computer, additional historical product demand information and additional historical causal factor information for said product;
updating, by said computer, said intermediate regression analysis results with said additional historical product demand information and additional historical causal factor information for said product;
determining, by said computer, a plurality of updated regression coefficients from said updated intermediate regression analysis results; and
blending, by said computer, said plurality of updated regression coefficients and corresponding plurality of factors for said product to determine an updated product demand forecast for said product.

2. The computer-implemented method for forecasting product demand for a product in accordance with claim 1, wherein:
said step of analyzing said historical product demand information and said historical causal factor information for said product to determine a plurality of regression coefficients corresponding to said plurality of factors comprises generating a plurality of linear equations associating said regression coefficients and historical values of said plurality of factors;
said step of storing intermediate regression analysis results generated during said determination of said regression coefficients comprises storing regression matrices corresponding to said plurality of linear equations; and
said step of updating said intermediate regression analysis results with said additional historical product demand information and additional historical causal factor information for said product comprises generating update term matrices and combining said update term matrices with said regression matrices to generate updated regression matrices.

3. A system for forecasting product demand for a product, comprising:
an electronic database containing historical product demand information and historical causal factor information for a plurality of factors influencing demand for said product;
a computer including a product forecasting application for:
analyzing said historical product demand information and said historical causal factor information for said product to determine a plurality of regression coefficients corresponding to said plurality of factors;
storing intermediate regression analysis results generated during said determination of said regression coefficients;
blending said plurality of regression coefficients and corresponding plurality of factors for said product to determine a product demand forecast for said product;.
receiving additional historical product demand information and additional historical causal factor information for said product;
updating said intermediate regression analysis results with said additional historical product demand information and additional historical causal factor information for said product;
determining a plurality of updated regression coefficients from said updated intermediate regression analysis results; and
blending said plurality of updated regression coefficients and corresponding plurality of factors for said product to determine an updated product demand forecast for said product;.

4. The system for forecasting product demand for a product according to claim 2, wherein:
said step of analyzing said historical product demand information and said historical causal factor information for said product to determine a plurality of regression coefficients corresponding to said plurality of factors comprises generating a plurality of linear equations associating said regression coefficients and historical values of said plurality of factors;
said step of storing intermediate regression analysis results generated during said determination of said regression coefficients comprises storing regression matrices corresponding to said plurality of linear equations; and
said step of updating said intermediate regression analysis results with said additional historical product demand information and additional historical causal factor information for said product comprises generating update term matrices and combining said update term matrices with said regression matrices to generate updated regression matrices.
